(19) United States
(12) Patent Application Publication
(10) Pub. No.: US 2015/0308674 A1
(43) Pub. Date: Oct. 29, 2015

(54) CIRCUIT BOARD AND LIGHT EMITTING DIODE LAMP HAVING THE SAME

(71) Applicant: HON HAI PRECISION INDUSTRY CO., LTD., New Taipei (TW)

(72) Inventors: KUANG-MING HSIAO, Tu-Cheng (TW); CHUN-WEI LIANG, Tu-Cheng (TW)

(21) Appl. No.: 14/513,734

(22) Filed: Oct. 14, 2014

(30) Foreign Application Priority Data
Apr. 24, 2014 (CN) 2014101675822

(51) Int. Cl. F21V 29/508; F21K 99/00; F21V 17/06; F21V 23/00; F21V 9/16

(52) U.S. Cl. CPC F21V 29/508; F21V 23/005; F21V 9/16; F21V 17/06; F21K 9/1355; F21Y 2105/001

(57) ABSTRACT

A circuit board for bearing a plurality of light emitting diodes includes a base and a bent portion. The bent portion extends and bends from a lateral periphery of the base. The base and the bent portion are integrally formed. An outer surface of the bent portion resists other component to embed and fix circuit board. This disclosure also discloses a light emitting diode lamp having the circuit board.

### FIELD

The subject matter herein generally relates to a circuit board and a lighting emitting diode (LED) lamp having the same.

### BACKGROUND

LEDs have low power consumption, high efficiency, quick reaction time, long lifetime, and the absence of toxic elements, such as mercury, during manufacturing. Due to those advantages, traditional light sources are gradually replaced by LEDs, and LED lamps are becoming increasingly popular.

A conventional LED lamp includes a circuit board and a plurality of LEDS arranged on the circuit board. The circuit board is a flat plate made of a metal, such as aluminum, and engages a heat dissipation device to dissipate heat generated by the LEDS. The circuit board and the heat dissipation device are usually connected via screws, which leads to a high cost of manufacturing the LED lamp. Simultaneously, the circuit board is easily warped partially when the screws are mounted thereto, which leads to uneven distribution of heat generated by the LEDS on the aluminum circuit board, and thereby effects a heat dissipation efficiency of the LED lamp.

### BRIEF DESCRIPTION OF THE DRAWINGS

Implementations of the present technology will now be described, by way of example only, with reference to the attached figures.

FIG. 1 is an isometric, assembled view of an LED lamp in accordance with a first exemplary embodiment of the present disclosure.

FIG. 2 is an exploded, perspective view of the LED lamp of FIG. 1.

FIG. 3 is an inverted view of the LED lamp of FIG. 1.

FIG. 4 is a cross-sectional view of the LED lamp, as taken along line IV-IV of FIG. 1.

FIG. 5 is an assembled view of a circuit board and a lamp housing in the LED lamp of FIG. 1.

FIG. 6 is an assembled, isometric view of a circuit board and a lamp housing in an LED lamp in accordance with a second exemplary embodiment of the present disclosure.

FIG. 7 is an assembled, isometric view of a circuit board and a lamp housing in an LED lamp in accordance with a third exemplary embodiment of the present disclosure.

### DETAILED DESCRIPTION

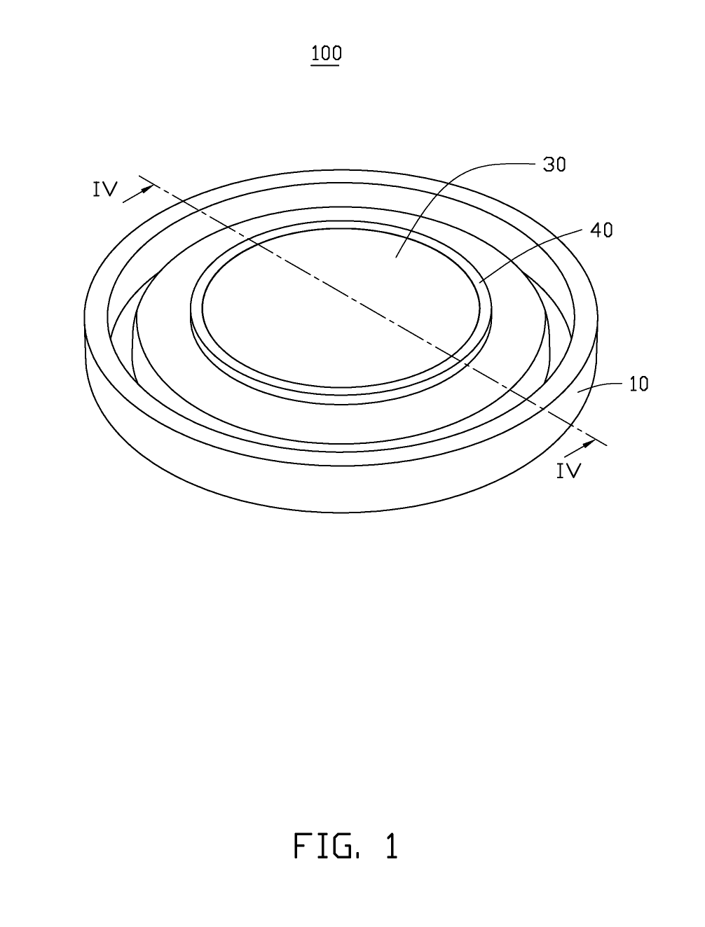

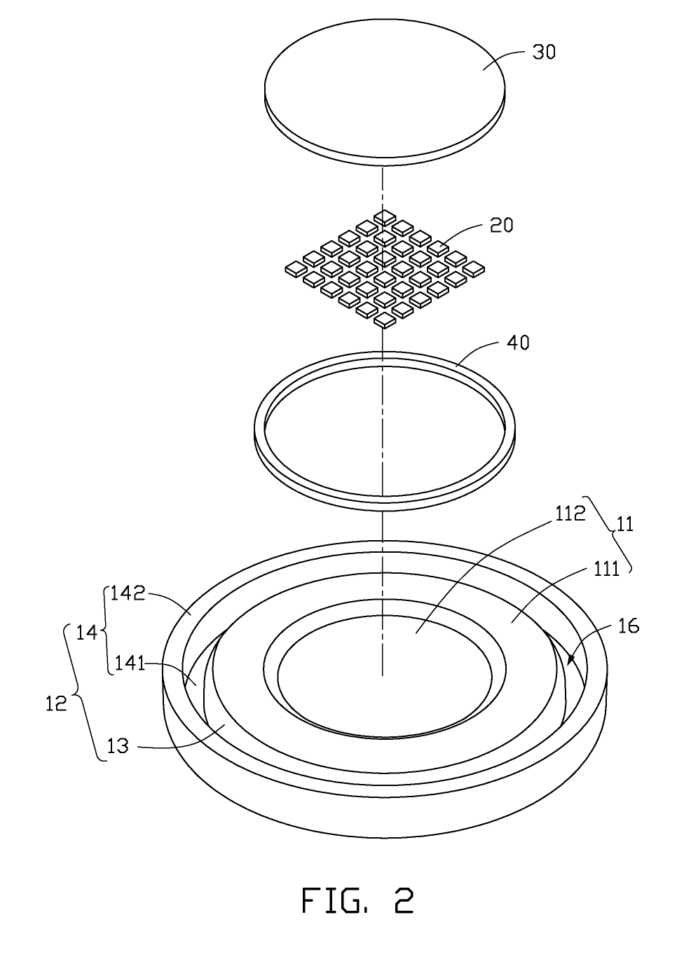

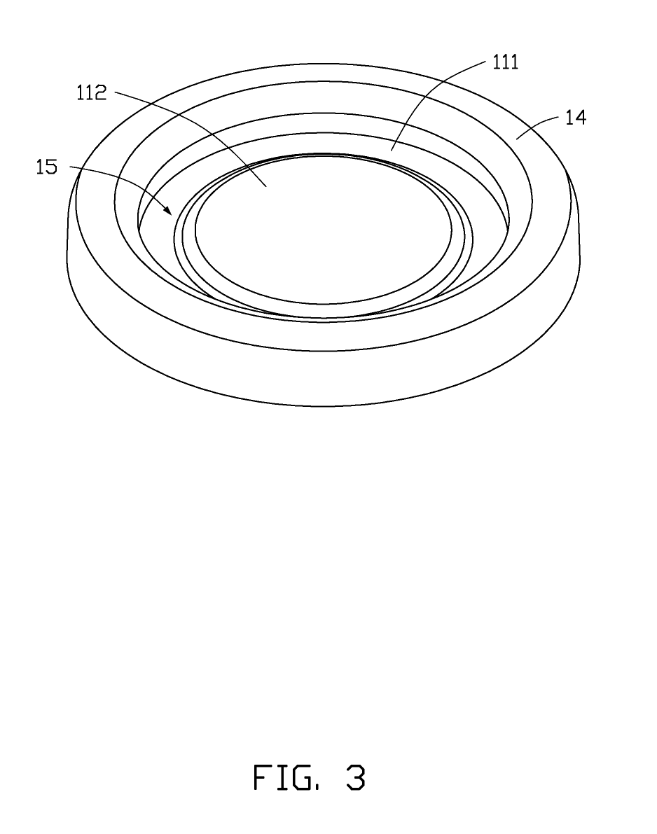

Referring to FIGS. 1 to 5, an LED lamp 100 in accordance with a first embodiment is provided. The LED lamp 100 includes a circuit board 10, a plurality of LEDs 20 arranged on the circuit board 10, an encapsulation layer 30 covering the LEDs 20, and an orientation ring 40 surrounding the encapsulation layer 30.

The circuit board 10 includes a base 11 and a bent portion 12 extending outwardly and bending from a lateral periphery of the base 11. In this embodiment, the circuit board 10 is an aluminum circuit board. Alternatively, the circuit board 10 can also be a fiberglass circuit board, a multiple layer multiplex circuit board, a flexible circuit board, a ceramic circuit board, or a plastic circuit board and, so on.

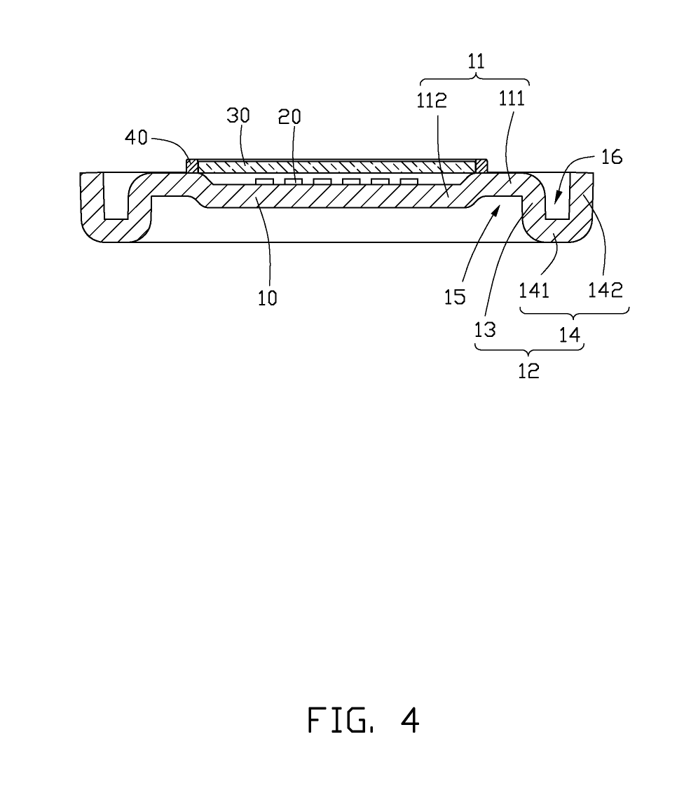

The base 11 is circular. The base 11 includes a connecting portion 111 at a periphery thereof and a positioning portion 112 at a center thereof. The connecting portion 111 is annular. The positioning portion 112 is depressed from an inner edge of the connecting portion 111 to support the LEDS 20. In this embodiment, the positioning portion 112 is circular. As shown in FIG. 4, a bottom surface of the positioning portion 112 is lower than a bottom surface of the connecting portion 111. Alternatively, a shape of the positioning portion 112 can be rectangular, triangular, and so on. A shape of the connecting portion 111 can be configured according to the shape of the positioning portion 112.

The bent portion 12 includes a sidewall 13 extending downwardly from the base 11 and an engaging portion 14 located at a periphery of the sidewall 13. The sidewall 13 integrally extends downwardly from an outer edge of the connecting portion 111. A height of the sidewall 13 is greater than a depressed depth of the positioning portion 112. The sidewall 13 is annular. In this embodiment, the sidewall 13 is perpendicular to the connecting portion 111. The sidewall 13 and the bottom surface of the base 11 together define a recess 15.

A cross-section of the engaging portion 14 is “L” shaped. The engaging portion 14 includes a connecting section 141 and an extending section 142. Specifically, the connecting section 141 extends horizontally from a bottom end of the sidewall 13, that is the bottom end of the sidewall 13 connects one end of the connecting section 141. The extending section 142 extends upwardly from the other end of the connecting section 141. A height of the extending section 142 is equal to that of the sidewall 13 to protect the LEDS 20 arranged on the base 11. An outer surface of the extending section 142 resists an external component such as lamp housing to embed and fix the circuit board 10.

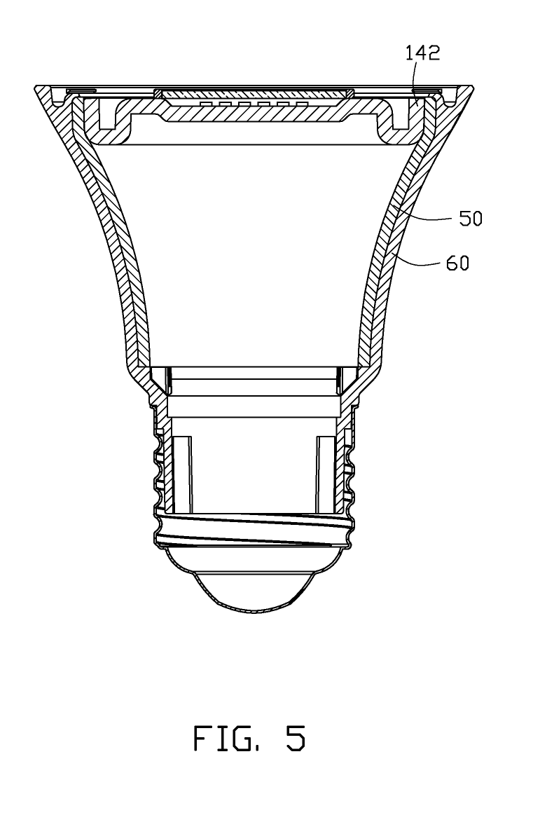

Referring to FIG. 5, the circuit board 10 and a lamp housing 60 are assembled. The lamp housing 60 includes a fastening plate 50. The outer surface of the extending portion 142 resist an inner surface of the fastening plate 50 to embed and fix the circuit board 10. Alternatively, the outer surface of the extending section 142 can also directly resist an inner surface of the lamp housing 60.

A cross-section of the sidewall 13 assembling the engaging portion 14 is “U” shaped. The sidewall 13, the connecting section 141, and the extending section 142 form the bent portion 12 to enhance a stability of the circuit board 10. The bent portion 12 buffers a thermal load generated by the circuit board 10. The positioning portion 112, the sidewall 13, and the engaging portion 14 are formed by a pressing method, a spinning method, a forging method, or an extruding method, and so on. The engaging portion 14 and the side wall 13 cooperate define a groove 16. The groove 16 is annular. The groove 16 can be used to embed other components. The groove 16 and the recess 15 are located at two opposite sides of the sidewall 13, that is the sidewall 13 separates the groove 16 and the recess 15.

The LEDs 20 are arranged on the base 11 of the circuit board 10 and received in the positioning portion 112. The LEDs 20 are arranged on the top surface of the base 11. The LEDs 20 electrically connects the circuit board 10. In this embodiment, each LED 20 is a blue LED chip. Alternatively, the LEDs 20 could be LED chips generating light of different colors. The LEDs 20 are mounted on the top surface of the positioning portion 112 by chip on board method.

The encapsulation layer 30 covers the LEDS 20 and is spaced from the LEDS 20. A shape of the encapsulation layer 30 is matched with that of the positioning portion 112. In this embodiment, the encapsulation layer 30 is circular. A size of the encapsulation layer 30 is slightly greater than that of the positioning portion 112. The encapsulation layer 30 is arranged to engage the inner edge of the connecting portion 111. A top surface of the encapsulation layer 30 is higher than that of the connecting portion 111. The top surface of the encapsulation layer 30 is lower than the top end of the extending section 142. The encapsulation layer 30 is made of transparent materials mixed with a phosphor. Alternatively, the encapsulation layer 30 can be embedded and received in the positioning portion 112, and the top surface of the encapsulation layer 30 is coplanar with the top surface of the connecting portion 111, such that the LED lamp 100 is thin with a relative small thickness.

The orientation ring 40 resists the periphery of the encapsulation layer 30 and is arranged on the connecting portion 111 for enhancing a stability of the encapsulation layer 30.

When the LED lamp 100 works, the bent portion 12 of the circuit board 10 provides sufficient surface area to evenly and quickly dissipate heat generated by the LEDS 20. Simultaneously, the LEDS 20 are received in the positioning portion 112 and protected by the bent portion 12, such that the stability of the LED lamp 100 is increased. In addition, the circuit board 10 can be connected with external component such as lamp housing via the outer surface of the extending surface 142 without screws, such that the LED lamp 100 can be manufactured quickly by cutting down cost of manufacturing the LED lamp 100.

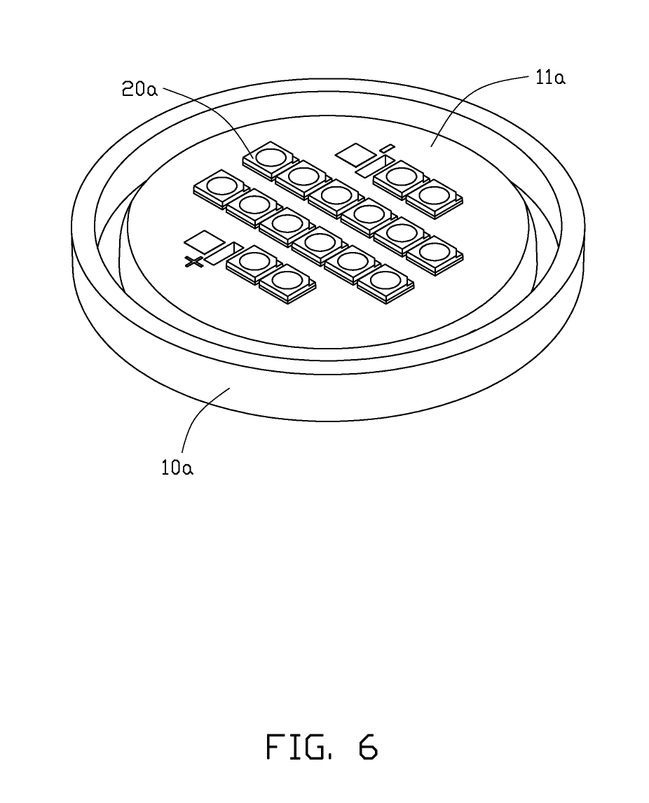

Referring to FIG. 6, a circuit board 10a assembled with a plurality of LEDS 20a, in accordance with a second embodiment,t is provided. The circuit board 10a is similar to the circuit board 10, the difference is that the base 11a is circular and a flat plate, that is there is no positioning portion 112 depressed at the center of the base 11a, and the LEDS 20a are evenly arranged on the base 11a. A cross-section of the circuit board 10a is “U” shaped. Alternatively, the LEDS 20a can be also arranged on the bottom surface of the base 11a.

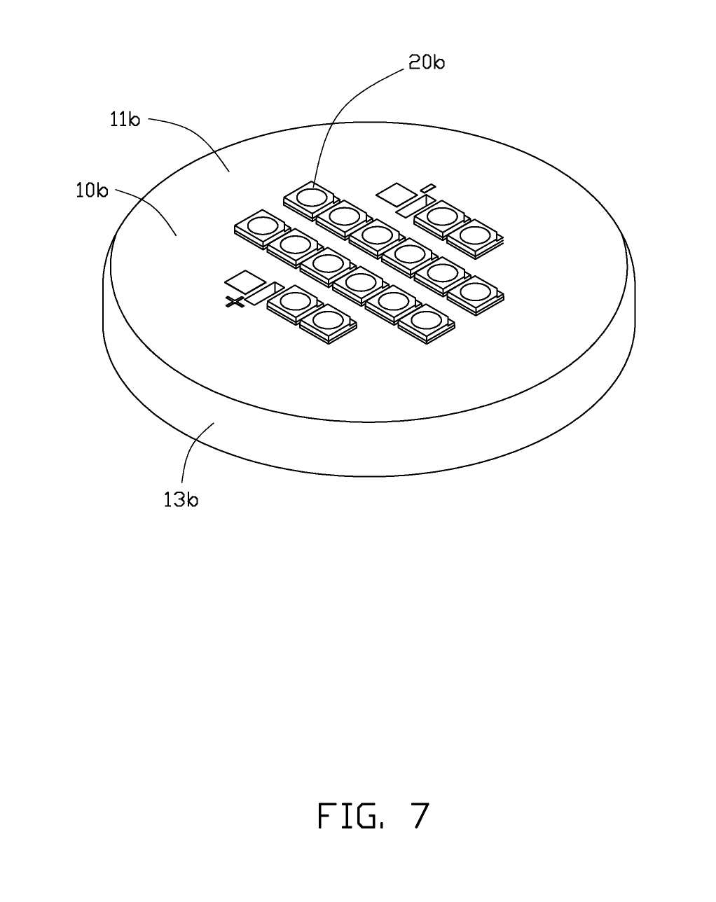

Referring to FIG. 7, a circuit board 10b assembled with LEDS 20b in accordance with a third embodiment is provided. The circuit board 10b is similar to the circuit board 10a of the second embodiment. The difference is that the circuit board 10b only includes a base 11b and a sidewall 13b extending downwardly from an outer periphery of the base 11b without forming any engaging portion 14 of the second embodiment, that is the bended portion 12 only includes the sidewall 13b. An outer surface of the sidewall 13b resists other component and be embedded to fix the circuit board 10b. The base 11b is a circular and flat plate. A cross-section of the circuit board 10b is “n” shaped.

It is to be further understood that even though numerous characteristics and advantages of the present embodiments have been set forth in the foregoing description, together with details of the structures and functions of the embodiments, the disclosure is illustrative only, and changes may be made in detail, including in matters of shape, size, and arrangement of parts within the principles of the disclosure to the full extent indicated by the broad general meaning of the terms in which the appended claims are expressed.

What is claimed is:

1. A circuit board for supporting a plurality of light emitting diodes (LEDS), comprising:
a base for supporting the LEDS; and
a bent portion extending outwardly and bending from a lateral periphery of the base, the bended portion and the base being integrally formed.

2. The circuit board of claim 1, wherein the circuit board is made of aluminum, the bent portion comprising a sidewall, the sidewall extending downwardly from the lateral periphery of the base.

3. The circuit board of claim 2, wherein the base comprises a positioning portion at a center thereof and an annular connecting portion surrounding the positioning portion, the positioning portion being depressed from an inner edge of the connecting portion, the sidewall extending downwardly from an outer edge of the connecting portion, a height of the sidewall is greater than a depressed depth of the positioning portion.

4. The circuit board of claim 3, wherein a bottom surface of the positioning portion is lower than a bottom surface of the connecting portion.

5. The circuit board of claim 2, wherein the bent portion further comprises an engaging portion, the engaging portion comprising a connecting section and an extending section, the connecting section extending horizontally from a bottom end of the sidewall, one end of the connecting section connecting with the sidewall, the extending section extending upwardly from the other end of the connecting section, a height of the extending section being equal to the height of the sidewall.

6. The circuit board of claim 5, wherein the base and the sidewall cooperate define a recess, the sidewall, the connecting section and the extending section cooperate define a annular groove, the groove and the recess are located at two opposite side of the sidewall.

7. A light emitting diode (LED) lamp comprising:
a plurality of LEDS;
a circuit board supporting the LEDS, the circuit board comprising a base supporting the LEDS, and a bent portion extending outwardly and bending from a lateral periphery of the base, the bended portion and the base being integrally formed; and
an engaging component engaged with an outer surface of the bent portion to embed and fix the circuit board.

8. The LED lamp of claim 6, wherein the circuit board is made aluminum, the bended portion comprising a sidewall, the sidewall extending downwardly from the lateral periphery of the base.

9. The LED lamp of claim 8, wherein the base comprises a positioning portion at a center thereof and an annular connecting portion surrounding the positioning portion, the positioning portion being depressed from an inner edge of the connecting portion, the sidewall extending downwardly from an outer edge of the connecting portion, a height of the sidewall is greater than a depressed depth of the positioning portion, the LEDS being received in the positioning portion.

10. The LED lamp of claim 9, wherein a bottom surface of the positioning portion is lower than a bottom surface of the connecting portion.

11. The LED lamp of claim 8, wherein the bent portion further comprises an engaging portion, the engaging portion comprises a connecting section and an extending section, the connecting section extending horizontally form a bottom end of the sidewall, one end of the connecting section connecting with the sidewall, the extending section extending upwardly from the other end of the connecting section, a height of the extending section being equal to the height of the sidewall, and an outer surface of the extending section resisting on the engaging component.

12. The LED lamp of claim 11, wherein the base and the sidewall cooperate define a recess, the sidewall, the connecting section and the extending section cooperate define a groove, the groove and the recess are located at two opposite side of the sidewall.

13. The LED lamp of claim 9 further comprising an encapsulation layer, wherein the encapsulation layer covers the LEDS and is spaced from the LEDs, a shape of the encapsulation layer being matched with that of the positioning portion.

14. The LED lamp of claim 13, wherein the a size of the encapsulation layer is greater than that of the positioning portion, the encapsulation layer being arranged on the inner edge of the connecting portion, a top surface of the encapsulation layer being higher than that of the connecting portion.

15. The LED lamp of claim 14, wherein an orientation ring resists a periphery of the encapsulation layer and is arranged on the connecting portion for strengthen a stability of the encapsulation layer.

16. The LED lamp of claim 13, wherein the encapsulation layer is embedded and received in the positioning portion, and the top surface of the encapsulation layer being coplanar with the top surface of the connecting portion.

17. A support for a plurality of light emitting diodes comprising:
A circuit board with a first side and a second side opposite to, and substantially parallel to, the first side, the circuit board having a base portion and a bent portion;
Wherein the circuit board base portion is peripherally surrounded by and integrally connected to the circuit board bent portion;
Wherein the plurality of light emitting diodes is positionable on the first side of the base portion of the circuit board; and
Wherein the bent portion of the circuit board forms an annular grooved protrusion extending outward from the second side of the circuit board.
